(19) United States
(12) Patent Application Publication
(10) Pub. No.: US 2007/0007211 A1
(43) Pub. Date: Jan. 11, 2007

(54) Methods, devices and compounds for dosing corrosion inhibitors cleaners and softening resins to water systems

(76) Inventor: David C. Sevier, Surrey (GB)

Correspondence Address: CASELLA & HESPOS, 274 MADISON AVENUE, NEW YORK, NY, 10016, US

(21) Appl. No.: 10/558,520

(22) PCT Filed: May 24, 2004
(86) PCT No.: PCT/GB04/02231

§ 371 Date: Nov. 28, 2005

Related U.S. Application Data
(60) Provisional application No. 60/473,533, filed on May 27, 2003.
(60) Provisional application No. 60/520,475, filed on Nov. 14, 2003.

(51) Int. Cl. C02F 5/00

(52) U.S. Cl. 210/696; 210/206

(57) ABSTRACT

A series of devices, methods and compounds for dosing corrosion inhibitors and cleaners to closed loop systems, boilers, towel rails, heat exchangers and heat stores. The devices and materials can be designed to allow corrosion inhibitors and cleaners to be built into boilers, radiators, heat stores, and any other similar devices. The chemicals are either bound into a gel or dissolved within the crystal lattice of a phase change compound. It is possible to design materials that will rapidly release the chemicals at elevated temperatures. These materials allow cold water flushing of systems without releasing the chemicals. The devices can also be modified to incorporated softening resin to remove the hardness from the system water and thereby prevent scaling.

Preventing corrosion in water filled closed loop systems through the use of chemical additives is a well established art and widely practiced. The additive systems that are available are effective and relatively inexpensive. Yet a very large number of closed loop systems, particularly domestic closed loop systems, are untreated in spite of the considerable cost savings, extended equipment and pipe work working life that can easily be had for very low cost. Similarly, many of these systems are not chemically cleaned. The problem is that the additives often do not get added by the installer or equipment owner. Often the causes are the difficulty of adding the inhibitor or cleaner to the system, cost cutting on the installer's part, ignorance of the benefits of adding corrosion inhibitors or, of the need to precommission clean systems.

Many equipment manufacturers warrantee equipment against defects and problems for a given period of time if corrosion inhibitors are added and the system and equipment are cleaned/flushed out to remove debris and swarf at the time of installation. In spite of this, considerable money is spent investigating and eventually rejecting warrantee claims as a result of not properly precleaning and inhibiting closed loop systems. Considerable savings could be had if the manufactures could be assured that the equipment was properly cleaned and protected from corrosion. In this vain, manufactures have tried to give away liquid corrosion inhibitor and cleaners with equipment in the hope that it would be added at the time of installation. This has had limited success as the chemicals are still often not added. At the opposite end of the spectrum, owners of large numbers of domestic properties such as housing authorities are often reduced to analysing closed loop system water after equipment installation to insure protection and proper cleaning. This testing costs money and is time consuming but the problem of failing to add inhibitors and cleaners is so wide spread that there is little choice.

It would be more straightforward if corrosion inhibitors could be stored within the equipment and released only after the system was flushed and cleaned. It would also be helpful if the same could be done with cleaners but with the chemical releasing engineered for when the system water becomes hot. This would insure that the equipment was protected from excessive corrosion and eliminate the problem of failing to clean and flush systems and, non-addition of corrosion inhibitors at the time of installation. Reduced warrantee claims and no need to test to insure that chemical addition has taken place would be the immediate benefits.

Equally the problem of scale formation is a problem in hard water areas. Water hardness is inversely soluble in hot water. This means that as water is heated up, a portion of the dissolved hardness becomes no longer soluble and will tend to plate out on the hottest point in the system as scale. As a result, boilers loose heat transfer efficiency because their hot water sections have high skin temperatures and attract scale. Recirculating pumps can also fail because of this. In some instances, glandless pumps can fail in as little as a month of operation due to scale problems. The effects of scaling are becoming increasingly felt, as system efficiencies are being pushed higher and smaller extra capacity margins are being designed into systems.

Ideally, systems should be filled and flushed with soft water to prevent scale formation. Due to the logistics of supplying temporary soft water in properties that only have hard water, this rarely takes place. The solution is to build in a quantity of softening resin into the equipment during manufacture to soften the water that fills the installed system. The resin can be encapsulated in a thermorelease gel or phase change compound to prevent the loss of capacity due to softening the water used for flushing and cleaning the system. The resin would only be revealed when the gel or phase change compound dissolves in hot water.

### SUMMARY OF INVENTION

There are a number means that the current addition methods of corrosion inhibitors and cleaners can be improved upon. The aim of these improvements is to make chemical addition either extremely easy for the installer/end user or to make it factory installed. This can be achieved through three primary ways: jellifying corrosion inhibitors and cleaners, creating inhibitor and cleaning systems that can be dissolved within phase change compounds, and mechanical devices. Variations and combinations of all three means are possible and can be advantageous. There is significant advantage if the phase change compound used to create an inhibitor or cleaning system is able to prevent corrosion or scale or is able to clean in itself, i.e. that it has scale prevention, corrosion inhibition or cleaning properties. Compounds such as simple and complex phosphates (pyrophosphate hydrate or disodium phosphate hydrate) have all the aforementioned properties.

Most materials are phase change compounds in that they undergo physical change when they melt, i.e. when a solid melts to liquid. Most of these compounds either melt at the wrong temperature range, do not allow the dissolving of inhibitor or cleaner systems in themselves or adversely affect corrosion and/or cleaning. There are also considerations regarding toxicity and cost of the phase change material. Generally the most suitable materials are ones that have water of crystallisation that can be used to dissolve the cleaning and inhibitor ingredients in.

Phosphate salts are widely used for preventing corrosion within domestic heating systems. These salts are effective at preventing corrosion when used in conjunction with other chemicals such as molybdate, polymers, phosphonates, biocides, and azoles. The phosphate salts have the advantage that they are of low toxicity and therefore lend themselves to domestic use.

Phosphate salts form crystals with water. The disodium and trisodium orthophosphate salts form crystals that can contain considerable water. Up to twelve molecules of water can be contained in disodium or trisodium phosphate crystals. The water of crystallisation of pH adjusted disodium phosphate can be used to make solid low melting temperature domestic central heating corrosion inhibitor systems. The other ingredients necessary to create a fully functioning inhibitor package are dissolved in warm liquid disodium phosphate.XH₂O where X represents the number of water molecules. The resulting formulation is then let cool and solidify. The formulation can be reheated and cooled a number of times and still retain its desired properties. Formulations that use either di or trisodium phosphate have the particular advantage that the phosphate is an inherent ingredient of the corrosion inhibitor formulation. Phosphates are well-recognised corrosion inhibitors in their own right.

The melting point of the corrosion inhibitor can be adjusted by varying the level of other ingredients, the pH of the formulation and by increasing or decreasing the amount of water used for crystallisation. Varying the water of crystallisation tends to be the easiest of the three options for controlling the melting point. Compounds that have melting points from the low 20s (Celsius) to the upper 90s (Celsius) can be created with pH adjusted disodium phosphate.

An example of a formulation that has a melting point between 50 to 55° C. can be made by mixing water at the proportion of 32% with disodium phosphate at the proportion of 40% and heating till the phosphate dissolves in the water. Polymers sodium molybdate, borax, and azole at the total proportion of 28% are dissolved in the mixture. The resulting mixture will solidify when cooled and remelts between 50 to 55° C. Biocide addition for system biological control is also possible. Typical biocide additions are 1 to 2%. Quaternary and tributyl tertadecyl phosphonium chloride biocides are effective and successfully formulate.

The phase change corrosion inhibitor formulations can be melted and injected into boiler corrosion cartridges, boiler tubes, radiators, towel rails, heat exchangers and heat stores to create units that have built in corrosion protection. The corrosion inhibitor will solidify on cooling and will only release corrosion inhibitor when the aforementioned objects are filled with water or are heated. The materials will dissolve slowly in cold water. In warm to hot water, the release is instantaneous once the phase change compound melts. In this way, phase change corrosion inhibitor formulations have a significant advantage over solid mixtures of the non-phase change inhibitor systems. The ingredients of the phase change compound are predissolved in the water of hydration of the phase change material and immediately release once the phase change corrosion inhibitor formulation melts. This is not the case with solid mixtures of non-phase change inhibitor systems. Each ingredient has to dissolve in the added water. This can take extended time and can prove to be difficult is achieve in practice.

For towel rails, there is a particular advantage in forming balls of a phase change corrosion inhibitor. 17 mm balls of corrosion inhibitor are easy to pour into the female opening of the 15 mm threaded connection that tends to be standard on European towel rails. The opening is 18.5 mm in diameter but when a male threaded connection is added, the opening reduces to 15 mm and traps the added balls of corrosion inhibitor within the towel rail. The round shape of the balls makes it easy to add them to the towel rail. The relatively large size of the balls makes it easy for dropped balls to be recovered and added to the towel rail. Similarly rods of phase change corrosion inhibitor are easy to add to towel rails. Pellets, tablets and powders of the corrosion inhibitor can also be added but spilt material is more problematic to recover.

Particularly hard spheres of phase change inhibitors can be made by dissolving molybdate and borate in a disodium phosphate hydrate. The resulting mixture is then kibbled (a process of grinding to produce large grained powders) with a copper corrosion inhibiting azole. The resulting mixture is then mixed with a powdered low molecular weight polymer and then compressed into spheres, tablets, or pellets. There are a number of polymers that can be used to prevent hardness scale formation and to keep the disodium phosphate solubilised. Polyacrylates with a molecular weight of 2000 to 4000 are but one example of polymers that can be used.

Any material that does not have adverse effects on corrosion or causes scaling/fouling and which has a large numbers of molecules of water for crystallisation can be used as the core material for forming the solid low temperature melting corrosion inhibition system. Borax is but one example of such a material. It will be apparent to others skilled in the art that variations upon these ideas are possible but which still retain the spirit of this invention.

Similarly, cleaning phase change formulations that have low melting points can be created that are based upon di and trisodium phosphate or upon sodium pyrophosphate hydrates. Formulations that are based around sodium pyrophosphate hydrate (the phase change compound), polyacrylate, phosphonates, succinate, and amides have been found to be particularly good cleaners. By varying the levels of each individual component, different cleaning and melting properties can be achieved. Many other formulations are possible that are based around low temperature phase change compounds.

These cleaning phase change compounds can be added to boilers, heat exchanges and the like in the same way that has been previously discussed for corrosion inhibitor phase change compounds. There is advantage in adding a small amount of dye to the cleaning phase change compound. When the tracer dye is released, it then allows the installer or the manufacturer to know if the cleaner has been successfully flushed out following the cleaning. Similarly, adding a small amount of dye to the inhibitor phase change compounds is helpful.

Creating hard spheres, tablets and pellets of phase change cleaners and then using them to dosing heating systems through an installed towel rail has particular advantage. This method is very straightforward.

Phase change corrosion inhibitors and cleaners can be added to heating systems through a small feeder as in figure thirteen. The feeder consists of a small chamber that is isolated from the heating system via a valve. The chamber is capped by a removable cap. The phase change corrosion inhibitor/cleaner is added to the addition chamber with the valve closed. When sufficient chemical is added, the top cap is sealed and the bottom valve opened. The chamber then fills with hot water that causes the phase change inhibitor to melt and release. The resulting liquid is heavier than water and therefore enters the main heating system.

Gels of corrosion inhibitors can be formed that have a variety of interesting properties. Gels can be formed using a number of jellifiers such as agars, alginates, and gelatines. It is possible to create gels based upon gelatine that melt and dissolve within water. Corrosion inhibitor gels that are based upon gelatine are extremely good at preventing corrosion. These gels generally will melt in the range of 25 to 35° C. This fairly low melting range limits the application as the gels can melt during shipping in warm weather conditions. Non melting gels or higher melting gels can be created by “hardening” the gel with a small addition of an aldehyde such as glutaraldehyde to the liquid gel mixture before setting. Already formed gels can be hardened to various degrees by immersing in a solution of an aldehyde for a given time.

Non-melting gels can also be formed with agars. Non-melting gels release their corrosion inhibitors by diffusion once the gel is immersed in water. Three percent agars release dissolved inhibitors within the gel to the surrounding water surprisingly quickly. Crushed gels release the majority of the corrosion inhibitor load in 10 to 60 minutes. Non-melting gels are particularly useful for thermal heat stores. Flexible socks filled with crushed gel can be easily added through one of the openings. The soft gels do not represent a hazard to the internal coils that could be damaged by hard materials during shipping. The gels release the corrosion inhibitors when the stores are filled with water. The undissolved agar gel is trapped within the sock and thus has no adverse effect on the heat store. The sock may or may not be weighted. Nylon stocking material, which can be used to package the crushed gel, is very stable in hot water conditions. It has an estimated stable working life of over 100 years within a hot thermal store.

An example of an agar corrosion inhibitor formulation is 1 to 3% agar, 2% gelatine, 5.3% sodium nitrite, 0.7% borax, 2.3% sodium molybdate, 0.5% benzyltriazole, 0.5% biocide, and 84.3% water. This produces a shippable non-leaking gel that provides excellent corrosion protection to metals within a heat store. This gel releases the corrosion inhibitors and biocide by diffusion. There are many other formulations that are possible that will be apparent to those familiar with this art.

The jellifiers can act as a future nutrient source. The lower the amount ofjellifiers used, the lower the future problem of bacteria infection. To further prevent this from being a problem, a biocide should be incorporated into the gel to prevent bacteria infections. The biocide should have persistence in the system for an extended period of time after the inhibitor has been released into the system.

Gels can be formed with most standard closed loop inhibitor systems if the dissolved solids level is kept below a certain level. This level varies depending upon the formula and the jelling agent that is used. For highly concentrated formulas, hollow gels can be produced that are filled with a liquid or slurry center of concentrated corrosion inhibitor. The encapsulated corrosion inhibitor is only released when the external gel melts. See figure one.

Jellified formulas of corrosion inhibitors contain a large amount of water by their very nature. As a result, when gels sit in water, diffusion of the corrosion inhibitors into the surrounding water will occur over time. The rate of this diffusion can be controlled by vying the surface ratio of gel to water. This can be done by placing the inhibitor in a container that has openings in it of various sizes and positions. As the inhibitor is heavier than water, the diffusion rate can also be controlled by where the openings in the container are.

Ideally, gel filled containers are incorporated into equipment during manufacture above any water that may be present. Further, if the equipment can be sealed, then the drying out of the gels can be prevented. This not essential as gels tend to be hydroscopic and absorb atmospheric humidity. Dried gels rehydrate when immersed in water. The dissolved ingredients will still diffuse out of dried gels. The packaging container surrounding the gels can also help prevent drying out.

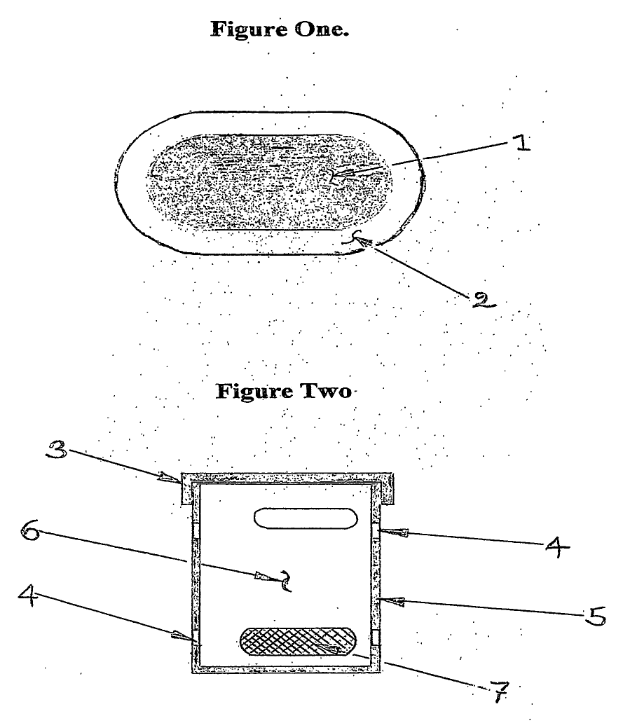

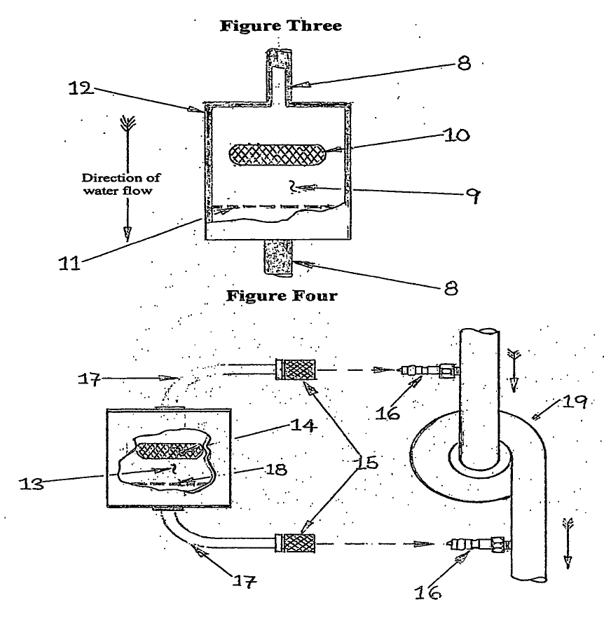

If gel or phase change corrosion inhibitor filled containers are used, packets of softener resin can be incorporated. See FIGS. 2 and 3. The resin in both systems is only exposed after the surrounding material has melted. Thus the softening capacity of the resin is preserved to soften the water that finally fills the equipment/system. Alternatively, resin can be administered in resin filled packets of metal or plastic-mesh. This method may require extra resin to be present as capacity will be lost, as the resin will absorb hardness during any water flushing process. Provision to prevent the resin drying out and cracking the beads will also need to be taken. Encapsulated resin will not suffer from this.

The dosing device in FIG. 3 is intended for incorporation into boilers or closed loop heating systems. This device is for dosing corrosion inhibitors or system cleaners. This device can be designed for slow or rapid releasing for the chemicals contained within. If high temperature (typically in the range of 70 to 95° C.) materials such as gels or phase change compounds such as hydrated orthophosphates or pyrophosphates are used to fill the arms of the device (8), then the chemicals contained in the main body of the device (9) will only be released when sufficient time at a given temperature has dissolved the chemicals in the arms of the device (8). To prevent absorption of heat from the warm air conditions within the boiler space, insulating the connecting tubes (8) is an advantage. In this way, it is possible to engineer arms that are of a particular length that will release a load of chemicals within the device after a predetermined period of time if the recirculating water is at a given temperature. In this way, it is possible to design a device that will only release corrosion inhibitors after the system has operated at a given period of time at temperature. This means that system cleaning and flushing can be carried out to provide precommission cleaning prior to the release of the corrosion inhibitors. A mesh screen or filter can be incorporated into the device (11) so that after the device has fully released its load of chemicals, it can act as a side stream filter to remove possible debris within the system. This aspect is particularly useful if the tube (12) is made clear. A device constructed in this way and filled with corrosion inhibitor would mean that boiler manufactures would be able to know if installers were complying with warrantee requirements that state that the system needs to be cleaned and flushed out at the time of installation. The device would not release its load of corrosion inhibitors until such a time that the installer would have theoretically cleaned and flushed the system. After this time, it would then act to capture system debris. Proper precommissioning cleaning and flushing would remove debris that would be otherwise captured by the device acting as a side stream filter. If the boiler or system required manufacture intervention, then the manufacture's agent would be able to tell if the warrantee requirements had been complied with. The strainer would only collect debris if the system had not been cleaned and flushed correctly. Thus manufactures would be able to prevent many inappropriate warrantee claims.

The device can also contain a packet of softener resin to remove system water hardness. The resin packet (10) is embedded within the corrosion inhibitor contained within the cartridge. The resins will only become exposed when the surrounding chemicals are dissolved. In this way, it is possible to avoid softening the water used for flushing the system.

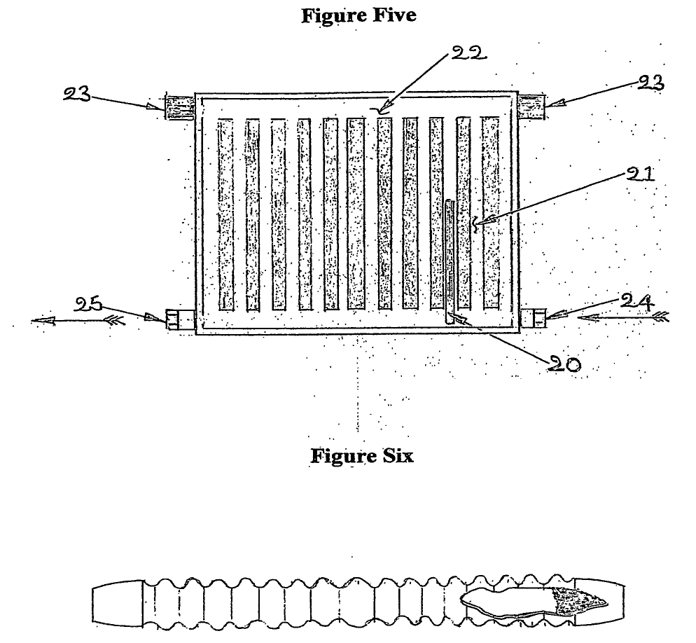

If standardised connection points could be agreed upon across a point of pressure differential such as the recirculation pump, and easy access engineering in, then it would be possible to create standardised devices for adding chemical. This would make dosing of chemicals and softening very easy. This could be further simplified by incorporating standard snap connections that include water stops. See FIG. 4. This would mean that old containers could be removed and new ones installed without wrenches. This would make it viable for the average person to add inhibitor to their heating system as the process would be quick, simple, not messy, and would not require the handling of any chemicals. Standardized containers of cleaning chemicals and corrosion inhibitors could also be made available for addition via this system.

Plastic straws that are filled with corrosion inhibitors in various forms (powdered, phase change corrosion inhibitors and gels) can also be produced. The straws can be made to be extra flexible by including corrugations. Standard bendable straws for drinking through are made this way. The straw would be tapered at one end to make it easier to thread into a radiator or towel rail through one of the top plugholes. Thus chemicals could be easily added to radiators and towel rails after installation. The straw could be left in the radiator provided that both ends of the straw were removed and the straw was made of a material that was suitably stable. Many modem radiators incorporate support rings that are installed on the four corners of the radiator. The support rings are disks with small holes drilled into them. The bendable straws thus are not suitable for dosing this type of radiator.

It is possible to incorporate straws that contain corrosion inhibitor directly into the radiator during the process of manufacture. The straw is installed in a vane of the radiator (20). The straw is placed in the vane before the radiator is fully welded together and painted. The selection of the corrosion inhibitor ingredients needs to be done with care as the manufacturing process of the radiator includes stoving the paint in an oven at high temperature for an extended period of time. While a number of inhibitor formulations as possible, the ingredients used must not vaporize or decompose within the high temperatures of the paint oven. Similarly, the ingredients must contain little or no water of hydration or the boiling of the corrosion mixture will occur during the stoving process. This causes problems with ingredients boiling out of the tube. A number of metals and plastics are acceptable for manufacture of the tube. The material selected needs to be capable of surviving the stoving process, and be sufficiently stable to provide controlled release of the ingredients within. The material of the tube must not adversely affect or cause corrosion or scaling/fouling. It is possible to select materials that will dissolve in the long term.

The height of the tube (31) in relationship to the height of the chemical (30) within affects the rate of release of the chemical. Similarly, the size of the opening (29) affects the release rate. The flow of water within an individual vane is fairly low. It is therefore possible to design inbuilt tubes containing corrosion inhibitor that will survive the flushing process of precommission cleaning before releasing the main body of inhibitor contained within.

A plug of material that dissolves in the long term can be inserted into the tube below the corrosion inhibition chemicals. In this way, after the tube releases the corrosion inhibitors, the tube will not become a long-term blockage.

To avoid the release of corrosion inhibitor from the tube during shipping and installation, there is advantage in covering the powdered corrosion inhibitors within the tube with a small amount of di or trisodium phosphate hydrate or borax. The material will loose water of hydration during the stoving process but if the quantity is controlled and the clear height of the tube above the chemical is sufficient, the chemical will not boil out. A fused mass of chemical will then effectively cap the chemical container there within.

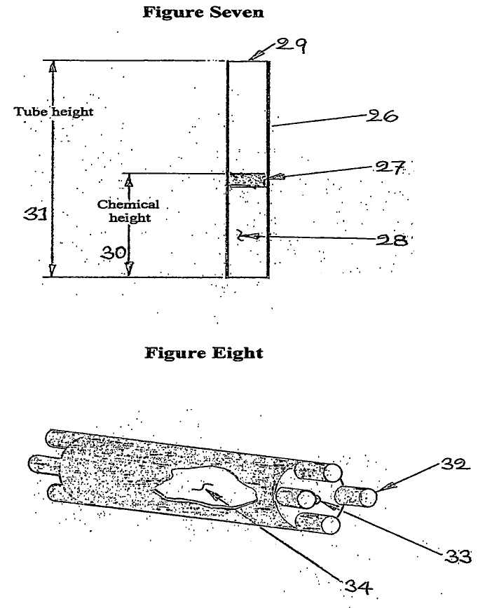

Plugs that are capable of the controlled release of corrosion inhibitor can be designed to be inserted within the top vent points of the radiator (23). The plugs are configured as in FIG. 8. The plugs are filled with corrosion inhibitors. The small hole (32) provides a controlled release of the chemical contained within. By varying the size of the hole, it is possible to design a device that will release the majority of corrosion inhibitor contained within after the cleaning and flushing process has occurred. The crown points (31) insure sufficient water flow around the device and allow air bleed vents to operate.

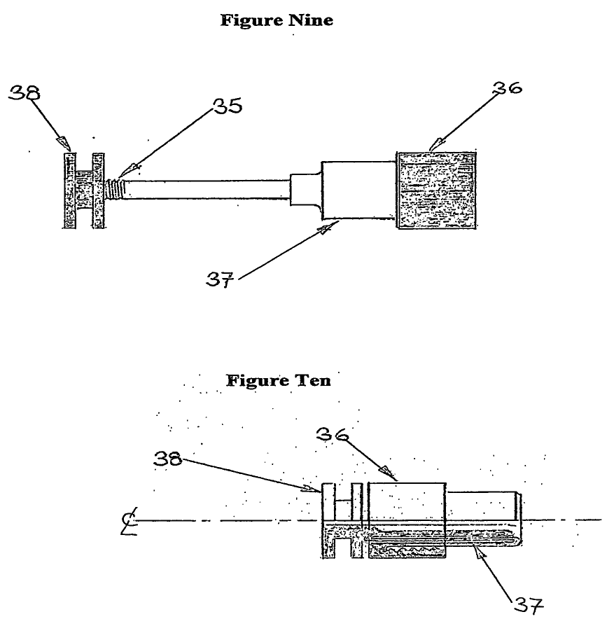

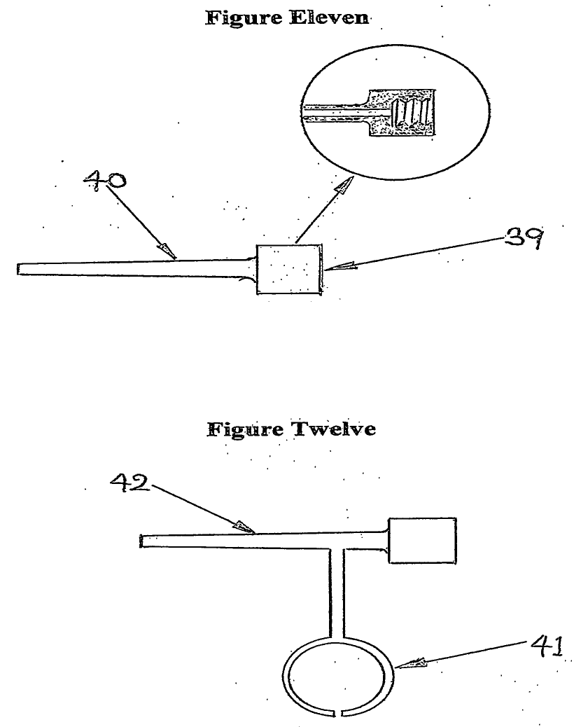

The ease with which liquid corrosion inhibition and cleaning formulations can be added to systems can be improved through the use of a flexible plastic pour spout cap that narrows to a fine point. This offers a significant advantage for adding liquid water treatment products to water systems. The pour spout cap allows the easy addition of chemicals to plugs at the top of radiators. In sealed domestic systems these may be the only feed points that are available. The pour spout needs to be flexible and long enough to allow the bending of the spout. See FIG. 9. The pour spout should also be retractable for easy storage and transport. It should also have a cap to seal the end of the pour spout during transport See FIG. 10. The entire pour spout cap needs to be sealable against the storage bottle.

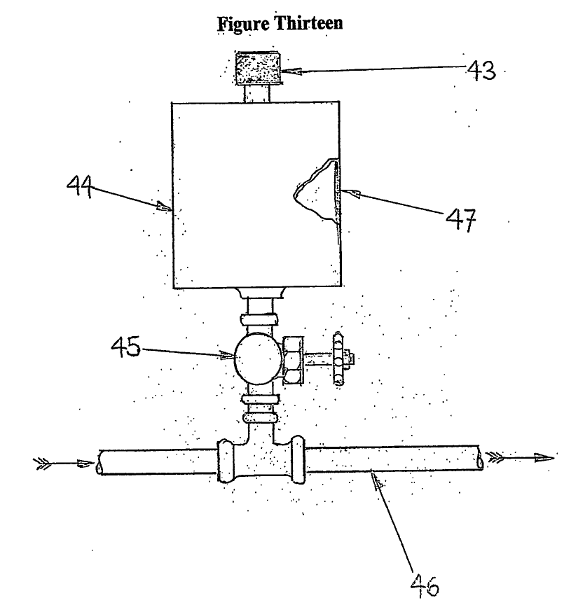

The pour spout can also have an attachable second piece to allow the further narrowing of the pour spout to allow injection into radiator air vents. Several brands of radiators lack plugs at the top of the radiator and they are installed on sealed systems. The small air vents may be the only viable chemical injection point. The narrowing piece is attached to the pour spout via a thread on the pour spout and the narrowing piece. The threading seal must be watertight and not leak when tightened up. The narrowing piece can take the form shown in FIG. 11.

The narrowing piece of FIG. 12 allows the direct inject of the chemical to air vents. It requires that the radiator be partly empty and that the bottle be squeezed to force the chemical out of the bottle. It is likely to require the lifting of the bottle from time to time to avoid air locks forming.

The narrowing piece can also have a built in tie attached to it to allow the easy attachment to the bottle. Alternatively, a split circle on a stem as shown in FIG. 12 can be used. Other variations are possible to allow the attachment of the narrowing piece to the bottle.

The addition of liquid inhibitors and cleaners can be further improved by packaging the chemicals within a spray can that is pressurised. A thin tube is attached to the spray nozzle so that spray is directed down the tube and into the point of addition. In this way, chemical can be added through radiator air vents.

### BRIEF DESCRIPTION OF DRAWINGS

Figure one is a hollow gel that is filled with liquid or slurried corrosion inhibitor.

Figure two is a gel, phase change inhibitor, or phase change cleaner filled container for diffusion and release control with openings and a mesh packet of softener resin.

Figure three is a two-port container filled with gel, phase change inhibitor, or phase change cleaner and resin packet.

Figure four is similar to figure three but unit has snap connections to allow easy connection to system. A system recirculation pump is shown with two snap connections. Variations of connections to system are possible.

Figure five shows a flat panel radiator with corrosion inhibitor releasing straw in one of the vanes.

Figure six shows tapered bendable straw filled with inhibitor or cleaner.

Figure seven shows straw that is part filled with corrosion inhibitor that is intended for placing with radiator during manufacture.

Figure eight shows device for placing within radiators for slow release of corrosion inhibitors.

Figure nine shows extended flexible pour spout cap that can be attached to liquid containers to make chemical addition easier.

Figure ten shows retracted pour spout cap.

Figure eleven narrowing piece for reduce diameter of extended pour spout sufficiently for dosing to small radiator air vents.

Figure twelve shows narrowing piece with bottle attachment.

Figure thirteen shows a heating system dosing device for phase change inhibitors/cleaners.

### DESCRIPTION OF EMBODIMENTS

In figure one, 1 is the center of liquid or slurried corrosion inhibitor and 2 is the outer gel that seals in the corrosion inhibitor. In figure two, 3 is a cap that can be fitted after the filling process. 4 are openings in the walls of the container to allow the inhibitor or cleaner to be released when it melts or diffuses out. 5 is the container that is made of plastic or metal. 6 is the corrosion inhibitor (jellified inhibitor or phase change inhibitor) or phase change cleaner. 7 is a quantity of resin that is confined in a packet of wire or plastic mesh.

In figure three, 8 are the small diameter pipes that connect to a water system across a point of pressure differential. This pipe is either left empty or is filled with high temperature melting gel or phase change compound. 9 is corrosion inhibitor (jellied inhibitor or phase change inhibitor). 10 is a quantity of resin that is confined in a packet of wire or plastic mesh. 11 is a screen, mesh or filter that is embedded in the corrosion inhibitor (9) that catches system debris after the corrosion inhibitor (9) has dissolved. 12 is the container.

In figure four, 13 is a liquid or slurry of corrosion inhibitor (jellied inhibitor or phase change inhibitor). 14 is a quantity of resin that is confined in a packet of wire or plastic mesh. 15 are easy to use snap type fittings. The fitting are designed so that they push into the fittings 16. Fittings 16 are designed to mate with fittings 15 and to prevent the loss of water when fitting 15 is not connected. 17 is small diameter pipe that is filled with high temperature melting gel or phase change compound. These tubes can be insulated to prevent external heat ingress. 18 is a screen, mesh or filter that is embedded in the corrosion inhibitor (13) that catches system debris after the corrosion inhibitor (13) has dissolved. 19 is a recirculation pump shown for demonstration purposes. A pump is not required, only a point of pressure differential is needed for the positioning of points 16.

In figure five, 20 is a straw containing corrosion inhibitor. 21 is vane within radiator. 22 is the radiator header that is filled with water when radiator is in operation. 23 is plug at top of radiator that may or may not be fitted with an air vent. 24 is water inlet connection. 25 is water outlet connection.

In figure seven, 26 is straw. 27 is compound for sealing corrosion inhibitor (28) in. 29 is opening in tube. 30 is the height of the chemical. 31 is the height of the tube.

In figure eight, 32 is castle point to help provide water flow around device. 33 is hole through outer shell of dosing device. 34 is corrosion inhibitor.

In figures nine and ten, 35 is are external threads on flexible pour spout. 36 is large hard plastic sealing cap with internal threads for sealing onto bottle. 37 is extended flexible pour spout. 38 is a small hard plastic sealing cap with threads.

In figure eleven and twelve, 39 is the internal threads on the narrowing piece 40 that allows dosing of liquids through air vents. 41 is split circle to allow easy attachment to bottle during storage and transport. 42 is neck of narrowing piece.

In figure thirteen, 43 is a threaded cap. 44 is the hollow chamber that the solid phase change corrosion inhibitor can be added to, 45 is a valve, 46 is a pipe of the heating system, 47 is the wall of the addition chamber (44).

1. A water treatment system for hot water heating systems comprising a solid-phase matrix material incorporating at least one active ingredient of: a corrosion inhibiting material, a scale inhibiting material and a pipe cleaning material, the matrix material retaining a release of the active ingredient against cold water flushing then releasing the active ingredient at a predetermined rate upon contact with water at heating temperatures.

2. The water treatment system of claim 1 wherein the solid-phase matrix material is preformed into a size and shape that may be introduced manually into an access port in a plumbing fixture.

3. The water treatment system of claim 1 wherein the solid-phase matrix material is a gel dissolving in water at heating temperatures to release the active ingredients.
The water treatment system of claim 1 wherein the solid-phase matrix material is a substantially non-dissolving gel from which the active materials diffuse.

5. The water treatment system of claim 4 wherein the solid-phase matrix material includes a retention network of insoluble fibres retaining the gel against dispersal in a hot water system.

6. The water treatment system of claim 1 wherein the solid-phase matrix material is a material experiencing a phase change between the temperatures of cold water and water at heating temperatures.

7. The water treatment system of claim 1 wherein the solid-phase matrix material is a corrosion inhibiting material.

8. The water treatment system of claim 1 wherein the solid-phase matrix material is phosphate salt.

9. The water treatment system of claim 1 where the active ingredient includes a water softening resin.

10. The water treatment system of claim 1 wherein the resin is encapsulated in a centre of the solid-phase matrix material to shield it from cold water and thereby to prevent premature softening of water used to flush the system.

11. A method of treating a hot water heating systems comprising the steps of:
(a) Introducing a solid-phase matrix material into the hot water heating system prior to use of the hot water heating system, the solid-phase matrix material incorporating at least one active ingredient of: a corrosion inhibiting material, a scale inhibiting material and a pipe cleaning material,
(b) Flushing the system with water at a temperature at which the matrix material retains the active ingredient; and
(c) Running the system with heated water so that the active ingredient is released from the solid-phase matrix material at a predetermined rate.

12. The method of claim 11 wherein the solid-phase matrix material is pre-formed into a size and shape that may be introduced manually into an access port in a plumbing fixture and where step (a) is a manual introduction of the solid-phase matrix material.

13. The method of claim 11 wherein the solid-phase matrix material is a gel dissolving in water at heating temperatures to release the active ingredients.

14. The method of claim 11 wherein the solid-phase matrix material is a substantially non-dissolving gel from which the active materials diffuse.

15. The method of claim 14 wherein the solid-phase matrix material includes a retention network of insoluble fibres retaining the gel against dispersal in a hot water system.

16. The method of claim 11 wherein the solid-phase matrix material is a material experiencing a phase change between temperatures of cold water and water at heating temperatures.

17. The method of claim 11 wherein the solid-phase matrix material is a corrosion inhibiting material.

18. The method of claim 11 wherein the solid-phase matrix material is phosphate salt.

19. The method of claim 11 where the active ingredient includes a water softening resin.

20. The method of claim 11 wherein the resin is encapsulated in a centre of the solid-phase matrix material to shield it from cold water and thereby to prevent premature softening of water used to flush the system.

21. An automatic release device for water treatment of hot water heating systems comprising a housing holding at least one active ingredient of: a corrosion inhibiting material, a scale inhibiting material and a pipe cleaning material, the housing including an environment sensitive port retaining a release of the active ingredient against cold water flushing then releasing the active ingredient at a predetermined rate upon contact with water at heating temperatures.

22. A dispensing system for water treatment chemical comprising: a container holding water treatment chemicals and having an opening for dispensing same; a spout attaching to the opening and providing a reduced diameter outlet that can be accepted by a port in a plumbing device.

23. A port for the introduction of water treatment chemicals comprising: a valve communicating with the plumbing system; a chamber sized to receive water treatment chemicals therein attached to the valve to communicate with the plumbing system when the valve is open; a watertight cap attached to the chamber to be resealably opened to allow the introduction of the water treatment chemical into the chamber.
It should be apparent to those skilled in the art that many variations are possible without departing from the spirit of this invention and described set of processes and devices.
